(19) United States
(12) Patent Application Publication
(10) Pub. No.: US 2020/0180697 A1
(43) Pub. Date: Jun. 11, 2020

(54) VEHICLE FRAME

(71) Applicants: Hyundai Motor Company, Seoul (KR); KIA Motors Corporation, Seoul (KR)

(72) Inventor: Seung Min JEONG, Hwaseong-si (KR)

(21) Appl. No.: 16/415,025

(22) Filed: May 17, 2019

(30) Foreign Application Priority Data
Dec. 10, 2018 (KR) 10-2018-0158450

(51) Int. Cl. B62D 21/15; B60K 1/04; B60L 50/60

(52) U.S. Cl. CPC B62D 21/15; B60K 1/04; B60Y 2306/01; B60K 2001/0438; B60L 50/66

(57) ABSTRACT

A vehicle frame, includes: a subframe disposed on a vehicle body; a battery frame disposed on the vehicle body and facing the subframe; and a guide support disposed between the subframe and the battery frame and guiding a movement of the subframe in a downward direction of the battery frame to avoid collision with the battery frame when the subframe moves toward the battery frame due to vehicle collision.

### CROSS REFERENCE TO RELATED APPLICATION

The present application claims priority to Korean Patent Application No. 10-2018-0158450, filed in the Korean Intellectual Property Office on Dec. 10, 2018, the entire contents of which is incorporated herein for all purposes by this reference.

### TECHNICAL FIELD

The present disclosure relates to a vehicle frame for preventing a battery from being damaged due to a subframe hitting the battery during vehicle collision.

### BACKGROUND

Due to environmental concerns and the increase in oil price, interest in an environmentally friendly vehicle has been increasing. Environmentally friendly vehicles include, for example, an electric vehicle and a hybrid electric vehicle, which are driven by using electrical energy.

The electric or hybrid electric vehicle has a high-voltage battery loaded on a lower part of a center floor, and protruding to a front part of the vehicle. It is necessary to protect the battery of the electric or hybrid electric vehicle, which is not a concern in an internal combustion engine vehicle. In addition, when the high-voltage battery of the electric or hybrid electric vehicle has a slight impact applied thereto, a coolant cooling the high-voltage battery may leak or may cause interference between electrodes in battery cells, resulting in a fire or damage in the battery.

When considering impact performance, in the conventional internal combustion engine vehicle, impact energy absorption alone is considered, on the other hand, in the electric or hybrid electric vehicle, both of battery protection and the impact energy absorption need to be considered. Particularly, as the electric or hybrid electric vehicle is relatively heavy in weight, during a head-on collision of the electric vehicle, a subframe is released from vehicle body and hits a battery, which damages the battery and has an impact on vehicle safety.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems occurring in the related art, and the present disclosure is directed to a vehicle frame for avoiding collision of a subframe moved by impact occurring during vehicle collision with a battery, such that the battery can be prevented from being damaged.

In order to achieve the above object, according to an exemplary embodiment of the present disclosure, a vehicle frame may include: a subframe disposed on a vehicle body; a battery frame disposed on the vehicle body and facing the subframe; and a guide support disposed between the subframe and the battery frame, and guiding a movement of the subframe in a downward direction of the battery frame to avoid collision with the battery frame when the subframe moves toward the battery frame due to vehicle collision.

The guide support may be fixed to the vehicle body and arranged between the subframe and the battery frame. The guide support has a first end portion facing the subframe and inclined downward toward the battery frame.

The guide support may have a higher rigidity than the subframe.

The subframe may have a second end portion, wherein the second end portion may face the guide support to be inclined downward toward the guide support.

The subframe may include a pair of side members connecting a front member with a rear member, wherein each of the side members may have a bending part provided on an upper part thereof, the bending part being depressed downward.

The battery frame may have a guide bracket on a third end portion thereof facing the subframe by protruding from the third end portion, wherein the guide bracket may have an inclined surface downward toward the battery frame.

The guide support may have a rod shape, a first end of which may be rotatably connected to the subframe and a second end of which may be rotatably connected to the battery frame.

The second end of the guide support may be located at a position higher than a position of the first end thereof, whereby when the subframe moves toward the battery frame, the first end may be rotated downward such that the subframe is rotated in the downward direction of the battery frame.

According to the vehicle frame having a structure described above, the subframe moved by impact occurring during vehicle collision avoids colliding with the battery by moving in the downward direction of the battery, whereby the subframe is prevented from being damaged due to collision with the battery.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a top plan view showing a vehicle frame according to the present disclosure;

FIGS. 2 to 4 are views illustrating a guide support of the vehicle frame according to a first exemplary embodiment of the present disclosure; and

FIGS. 5 and 6 are views illustrating a guide support of the vehicle frame according to a second exemplary embodiment of the present disclosure.

### DETAILED DESCRIPTION

Hereinbelow, exemplary embodiments of the present disclosure will be described in detail with reference to the accompanying drawings.

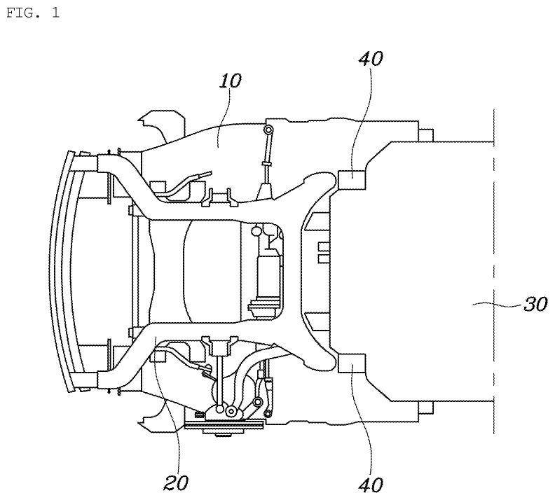

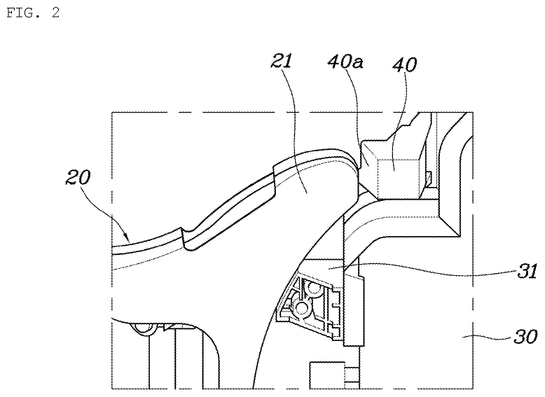

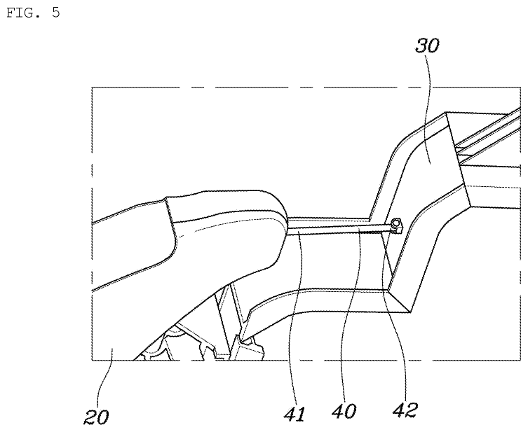

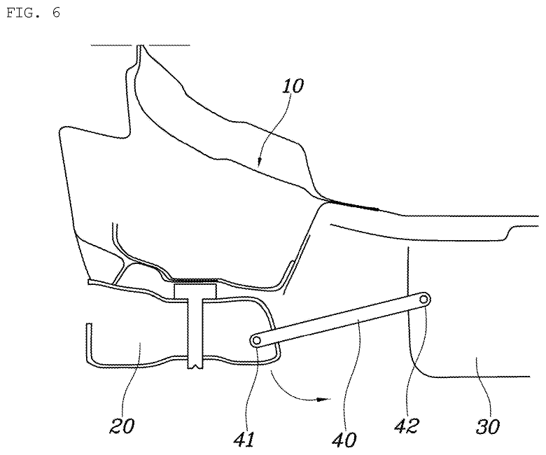

FIG. 1 is a top plan view showing a vehicle frame according to the present disclosure, FIGS. 2 to 4 are views illustrating a guide support of the vehicle frame according to a first exemplary embodiment of the present disclosure, and FIGS. 5 and 6 are views illustrating a guide support of the vehicle frame according to a second exemplary embodiment of the present disclosure.

As shown in FIG. 1, a vehicle frame according to the present disclosure includes: a subframe 20 disposed on a vehicle body 10; a battery frame 30 disposed on the vehicle body 10 so as to face the subframe 20; and a guide support 40 disposed between the subframe 20 and the battery frame 30. The guide support 40 guides the subframe 20 such that the subframe 20 can move in a downward direction of the battery frame 30 so as to avoid hitting the battery frame when the subframe 20 moves toward the battery frame 30 due to vehicle collision.

The vehicle frame according to the present disclosure may be applied to an electric vehicle or a hybrid vehicle and includes the battery frame 30 for seating a battery module provided therein. That is, the subframe 20 is mounted on the vehicle body 10 on a lower part of a vehicle body and has a drive motor and various kinds of parts sitting thereon, and the battery frame 30 may be mounted on the vehicle body 10 and have the battery module sitting thereon, wherein the battery module includes multiple cells.

The subframe 20 and the battery frame 30 are arranged so as to face each other on the lower part of the vehicle body in forward/rearward directions thereof, and for a stable structure, the subframe 20 is positioned on a front side of the vehicle body and the battery frame 30 is positioned on a rear side thereof. Accordingly, during a head-on collision of a vehicle, in general, the subframe 20 is released from the vehicle body 10 and moves to the battery frame 30. In this case, when the subframe 20 hits a battery module sitting on the battery frame 30, the battery module is damaged, which may cause a fire.

To solve the above problem, according to the present disclosure, the guide support 40 is disposed between the subframe 20 and the battery frame 30 and guides the subframe 20 to move in a downward direction of the battery frame 30 so as to avoid hitting the battery frame 30 when the subframe 20 moves toward the battery frame 30 due to vehicle collision. That is, during a head-on collision of a vehicle, the guide support 40 can guide the movement of the subframe 20 in the downward direction of the battery frame 30, whereby the subframe 20 can be prevented from colliding with the battery frame 30. Accordingly, the battery module sitting on the battery frame 30 can be prevented from being damaged and accidents due to damage of the battery module are prevented while improving reliability and stability of a vehicle.

The guide support 40 of the present disclosure described above may be applied according to various embodiments as described hereinbelow.

According to a first exemplary embodiment of the present disclosure, as shown in FIGS. 2 to 4, the guide support 40, which is fixed to the vehicle body 10, is arranged between the subframe 20 and the battery frame 30. The guide support 40 may have a first end portion 40a facing the subframe 20 and may be inclined downward toward the battery frame 30.

Accordingly, as shown in FIG. 2, the guide support 40 can be disposed between the subframe 20 and the battery frame 30, and the first end portion 40a of the guide support 40 facing the subframe 20 is inclined downward. Thus, during the movement of the subframe 20 due to vehicle collision, the subframe 20 moves downward along the inclined surface of the guide support 40 and may avoid colliding with the battery frame 30.

Here, the guide support 40 may have a higher rigidity than the subframe 20. Accordingly, when the subframe 20 comes into contact with the guide support 40, the guide support 40 is prevented from deforming. Accordingly, the guide support 40 allows the subframe 20 to move stably in the downward direction of the battery frame 30.

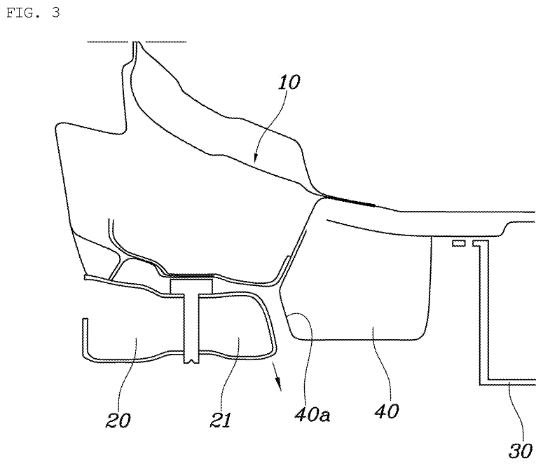

In addition, as shown in FIG. 3, the subframe 20 has a second end portion 21 facing the guide support 40 and inclined downward toward the guide support 40. Accordingly, an inclined surface on the second end portion 21 of the subframe 20 corresponds the inclined surface of the guide support 40, and thus, the downward movement of the subframe 20 can be efficiently performed.

In addition, as shown in FIG. 2, the battery frame 30 has a guide bracket 31 on a third end portion of the battery frame 30 facing the subframe 20 by protruding from the third end portion. The guide bracket 31 has a surface inclined downward toward the battery frame 30. Accordingly, the guide bracket 31 can guide the subframe 20 in cooperation with the guide support 40 such that the subframe 20 can move in the downward direction of the battery frame 30 during the movement of the subframe 20.

Accordingly, as shown in FIG. 3, when, due to the head-on collision, the subframe 20 is released from the vehicle body 10 and moves in the rearward direction, the second end portion 21 moves downward while being in contact with the guide support 40. In this case, as each of the second end portion 21 of and the first end portion 40a has the inclined surface, the subframe 20 may be efficiently guided to move in the downward direction of the battery frame 30 by sliding on the inclined surface of the guide support 40. In addition, the guide bracket 31 of the battery frame 30 may absorb impact occurring while coming into contact with the subframe 20, thus securing structural rigidity. Furthermore, the guide bracket 31 guides the movement of the subframe 20, and the subframe 20 can move effectively in the downward direction of the battery frame 30.

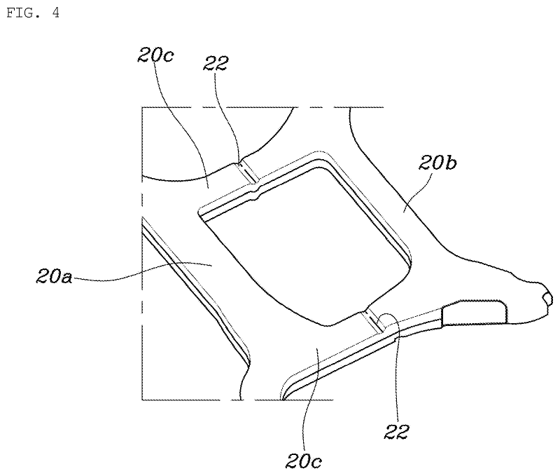

Referring to FIG. 4, the subframe 20 includes a pair of side members 20c connecting a front member 20a with a rear member 20b. Each of the side members 20c has a bending part 22 on an upper part thereof, the bending part 22 being depressed downward. The bending part 22 may extend in a direction in which each of the front member 20a and the rear member 20b extends from the side member 20c. Furthermore, the bending part 22 is configured to be depressed downward and thus allows the side member 20c to be deformed relative to the bending part 22 during vehicle collision. In addition, the bending part 22 is provided on an upper part of the side member 20c and thus allows the side member 20c to be curvedly deformed downward.

Accordingly, when vehicle collision occurs, the side member 20c of the subframe 20 is deformed downward relative to the bending part 22 and has a ‘v’ shape. Accordingly, due to the deformation of the side member 20c, impact energy is absorbed.

According to a second exemplary embodiment of the present disclosure as shown in FIGS. 5 and 6, the guide support 40 may be a rotation bar, a first end 41 of which is rotatably connected to the subframe 20 and a second end 42 of which is rotatably connected to the battery frame 30.

Accordingly, the guide support 40 is disposed between the subframe 20 and the battery frame 30 and has a bar shape, the first end 41 of the guide support 40 being rotatably connected to the subframe 20 and the second end 42 thereof being rotatably connected to the battery frame 30. Accordingly, during a movement of the subframe 20 due to vehicle collision, the subframe 20 is rotated downward by rotation of the guide support 40, and therefore, the subframe 20 can avoid colliding with the battery frame 30.

Here, the second end 42 of the guide support 40 is located at a position higher than a position of the first end 41 thereof, whereby when the subframe 20 moves toward the battery frame 30, the first end 41 is rotated downward such that the subframe 20 may be rotated in the downward direction of the battery frame 30. Accordingly, when the subframe 20 moves to the battery frame 30 due to vehicle collision, the first end 41 of the guide support 40 is rotated downward by a position difference between the first end 41 and the second end 42, and therefore, the subframe 20 can move in the downward direction of the battery frame 30 so as to avoid impact the battery frame 30.

Accordingly, according to a second exemplary embodiment, as shown in FIG. 6, when the subframe 20 is released from the vehicle body 10 by the head-on collision and moves rearward, the subframe 20 is induced to move downward by the rotation of the guide support 40, which is rotatably connected to the subframe 20 and the battery frame 30. Accordingly, direct impact of the subframe 20 on the battery frame due to contact of the subframe 20 with the battery frame 30 is minimized and damage of the battery module due to reduction of impact energy of the battery frame due to the contact is prevented.

According to the vehicle frame having the structure described above, during vehicle collision, the subframe 20 moves in the downward direction of a battery, whereby the battery can be prevented from being damaged due to collision of the subframe 20 with the battery.

Although the exemplary embodiments of the present disclosure have been described for illustrative purposes, those skilled in the art will appreciate that various modifications, additions and substitutions are possible, without departing from the scope and spirit of the disclosure as disclosed in the accompanying claims.

What is claimed is:

1. A vehicle frame, comprising:
a subframe disposed on a vehicle body;
a battery frame disposed on the vehicle body and facing the subframe; and
a guide support disposed between the subframe and the battery frame, the guide support guiding a movement of the subframe in a downward direction of the battery frame to avoid collision with the battery frame when the subframe moves toward the battery frame due to vehicle collision.

2. The frame of claim 1, wherein the guide support is fixed to the vehicle body and arranged between the subframe and the battery frame, and
wherein the guide support has a first end portion facing the subframe and inclined downward toward the battery frame at an angle greater than 0 (zero) degree.

3. The frame of claim 2, wherein the guide support has a rigidity higher than that of the subframe.

4. The frame of claim 2, wherein the subframe has a second end portion facing the first end portion of the guide support and inclined downward to correspond to the first end portion.

5. The frame of claim 2, wherein the subframe includes a pair of side members, a front member, and a rear member,
wherein the pair of side members connect the front member with the rear member, and each of the pair of side members has a bending part recessed into an upper part thereof.

6. The frame of claim 2, wherein the battery frame has a guide bracket on a third end portion of the battery frame, the guide bracket facing the subframe and protruding from the third end portion, and
wherein the guide bracket has a surface inclined downward at an angle of more than 0 (zero) degree toward the battery frame.

7. The frame of claim 1, wherein the guide support has a rod shape, a first end of which is rotatably connected to the subframe and a second end of which is rotatably connected to the battery frame.

8. The frame of claim 7, wherein the second end of the guide support is located at a position higher than that of the first end thereof,
wherein, when the subframe moves toward the battery frame, the first end of the guide support is rotated downward such that the subframe is rotated in the downward direction of the battery frame.
